(19) United States
(12) Patent Application Publication
(10) Pub. No.: US 2024/0400820 A1
(43) Pub. Date: Dec. 5, 2024

(54) POLYHYDROXYALKANOATE CAPSULE FOR BEVERAGE PREPARATION

(71) Applicant: MY TEA CUP AG, Horgen (CH)

(72) Inventors: Max SANDHERR, Männedorf (CH); Jacques SCHAEFFER, Le Mont-Pèlerin (CH); Laurent MASSACRIER, Cournon-d'Auvergne (FR)

(73) Assignee: MY TEA CUP AG, Horgen (CH)

(21) Appl. No.: 18/731,539

(22) Filed: Jun. 3, 2024

(30) Foreign Application Priority Data
Jun. 5, 2023 (FR) FR2305635

(51) Int. Cl. C08L 67/04; B29D 22/00; B29K 29/00; B29K 105/00; B29K 105/16; B65B 29/02; B65D 65/46; B65D 85/804; C08K 3/34

(52) U.S. Cl. CPC C08L 67/04; B29D 22/003; B65B 29/022; B65D 65/466; B65D 85/8043; C08K 3/34; B29K 2029/04; B29K 2105/0002; B29K 2105/0085; B29K 2105/16; B29K 2995/006; B29K 2995/0067; B29K 2995/0077; B29K 2995/0089; B29K 2995/0094; C08K 2201/003; C08L 2201/06; C08L 2205/025

(57) ABSTRACT

The invention relates to a capsule for the preparation of a beverage, said capsule comprising a container including at least one side wall having a circular rim, wherein the sidewall and the circular rim are formed by injection molding or thermoforming of at least one formulation comprising:
(i) at least one polymer P1 chosen from polyhydroxyalkanoates (PHA); and
(ii) at least one polymer P2 chosen from polyhydroxyalkanoates (PHA), said polymer P1 having a degree of crystallinity (KC1) greater than or equal to 50%, and said polymer P2 having a degree of crystallinity (KC2) of less than or equal to 30%, preferably less than or equal to 5%.

### TECHNICAL FIELD OF THE INVENTION

The present invention relates to the field of biodegradable and compostable closed, single-use capsules, by industrial composting and/or by domestic composting or which can be broken down by anaerobic digestion (methanizable), containing at least one edible substance. The edible substance may be in powder form for the preparation of a beverage, e.g. coffee, intended to be extracted under pressure or under temperature, or in liquid form for the preparation of a beverage, e.g. lemonade or food supplements, designed to be extracted at low pressure and low temperature or ambient temperature.

### PRIOR ART

Pre-dosed and pre-packaged portions of coffee are widely used for preparing espresso-type coffees as same are simple and easy to use.

There are generally two types of capsules on the market, rigid capsules typically consisting of a container and a seal and flexible capsules containing filter layers. The present invention relates to the first category of capsule.

Rigid capsules such as the Nespresso® capsules are widely used in Europe. Such capsules comprise a body or a container and a seal which are traditionally made essentially of aluminum.

The final beverage dispensing process follows the following pattern: a fluid, such as water or milk, is injected into the capsule to interact with the substance contained in the capsule to produce the desired beverage, and when a sufficient amount of fluid fills the capsule, the latter opens under the pressure of the fluid to release the prepared beverage.

For example, the opening of the capsule can be accomplished by pressing an extraction face of the capsule with a force performed by increasing the pressure of the fluid inside the capsule against an opening structure provided in the capsule-holder so that the extraction face is torn when same reaches a stress of rupture of the latter. The opening structure may be a certain number of raised and recessed elements, e.g. pyramidal elements, on which the extraction face extends and tears under the effect of the internal pressure of the fluid. Such a pressure-controlled beverage preparation has the advantage of being able to produce a high-quality beverage.

There are also capsules wherein the seal and the body are made of plastic materials.

The application WO2021/239982A1 in the name of the applicant describes a closed capsule, the bottom, the side wall and the circular rim of which are formed by injection molding of at least one formulation comprising:
(i) at least one polymer chosen from polyhydroxybutyrates, and
(ii) at least one ingredient chosen from silicates, vitamins E, plasticized proteins of animal or plant origin, or mixtures thereof.

The capsules of the prior art which use thermoplastic materials may have the drawback of being fragile and may sometimes break during the production line or during the uses thereof even though the capsules have a very good barrier function against oxygen and/or water vapor. It has been found in the prior art that, during the manufacture of crystalline polyhydroxyalkanoate (PHA) capsules, a large variation in the mechanical properties of the capsule was obtained due to the poor thermal stability of the PHA. The capsules of the prior art can also deform and/or break when subjected to temperature stresses.

The applicant has thus developed a new capsule which makes it possible to overcome the problems of the prior art while preserving the good barrier function against oxygen and/or water vapor.

Therefore, a subject matter of the present invention is to provide capsules which are rigid but not brittle while having a good barrier function against oxygen and water vapor and while ensuring constant mechanical characteristics, good temperature resistance, both during the uses thereof in an extraction machine and during the manufacture while reducing production defects. The capsules are also biodegradable by industrial composting and/or by domestic composting or can be even broken down by anaerobic digestion, and make it possible to prepare a drink, such as coffee, of satisfactory quality, when the capsules are used in an espresso machine, in particular a Nespresso® machine.

### SUMMARY OF THE INVENTION

More precisely, the present invention relates to a capsule for the preparation of a beverage, said capsule comprising a container including at least one side wall having a circular rim, the side wall and the circular rim being formed by injection molding or thermoforming of at least one formulation comprising:
(i) at least one polymer P1 chosen from polyhydroxyalkanoates (PHA); and
(ii) at least one polymer P2 chosen from polyhydroxyalkanoates (PHA),
said polymer P1 having a degree of crystallinity (Kc1) greater than or equal to 50%,
and said polymer P2 having a degree of crystallinity (Kc2) of less than or equal to 30%, preferably less than or equal to 5%.

According to an embodiment, the capsule has one or a plurality of the following features:
said polyhydroxyalkanoates are chosen from polyhydroxybutyrate (PHB) polymers, preferably the polymer P1 and/or the polymer P2 are copolymers PHB, and/or
the polymer P1 contains monomer units M1a of hydroxybutyrates 3HB and monomer units M1b chosen from hydroxyvalerate HV, 3-hydroxyhexanoate HH or 4hydroxybutyrate 4HB, M1a being different from M1b, and/or the polymer P2 contains monomer units M2a of hydroxybutyrates 3HB and monomer units M2b chosen from hydroxyvalerate HV, 3-hydroxyhexanoate HH or 4-hydroxybutyrate 4HB, M2a being different from M2b, preferably the weight ratio M1b/M1a being less than or equal to 0.07, preferably less than or equal to 0.6 and/or the M2b/M2a weight ratio being greater than or equal to 0.05, preferably ranging from 0.1 to 1, else preferably from 0.2 to 0.9, and/or
the polymer P1 and/or the polymer P2 are obtained by aerobic and/or anaerobic fermentative engineering in a biosourced way (or bio-based way) and/or
the polymer(s) P1 represent(s) from 70 to 99% by weight, preferably from 80 to 98% by weight, of the total weight of the polymers P1 and P2 and/or the polymer(s) P2 represent(s) from 1 to 30% by weight, preferably from 2 to 20% by weight, else preferably from 3 to 10% by weight, relative to the total weight of the polymers P1 and P2, and/or
the formulation comprises from 50 to 99.9% by weight, preferably from 75 to 99.5% by weight and advantageously from 90 to 99% by weight, of the total weight of the formulation, and/or
the formulation further comprises at least one inorganic or organic filler, preferably in a proportion ranging from 0.1 to 50% by weight, preferably from 0.5 to 25% by weight, advantageously from 1 to 15% by weight, preferably said filler being chosen from silica, silicates, double laminar hydroxides (HDL), titanium oxide, vitamin E, plasticized animal or vegetable proteins, or mixtures thereof, with respect the total weight of the formulation, and/or
the BET specific surface area of the silicates ranges from 1 to 250 m²/g and/or the median diameter of the silicates is comprised between 0.5 to 20 μm and/or the dimensional form factor of the silicates is greater than or equal to 1:2, and/or
the formulation further comprises at least one polyvinyl alcohol or ethylene vinyl, preferably in a quantity ranging from 1 to 30% by weight, preferably from 2 to 20% by weight, advantageously from 5 to 10% by weight, with respect to the total weight of the formulation, and/or
said capsule:
   is biodegradable and/or compostable under industrial or domestic conditions or by anaerobic digestion and/or
   contains at least 80% by weight of bio-based carbon, with respect to the total weight of the carbon atoms of the capsule, and/or
the container includes a bottom and the bottom, the side wall and the circular rim are formed by injection molding or by thermoforming, preferably in only one layer of said formulation in a mold, and/or
the capsule contains a substance in the form of powder or liquid, said capsule comprising a seal welded on the circumference of the rim of the container, preferably the seal comprising a monolayer or multilayer film, said film comprising one or a plurality of materials chosen from biodegradable materials, and which can be composted according to an aerobic biological process and which can be broken down by anaerobic digestion according to an anaerobic processus, preferably the material being chosen from paper, nonwoven fabrics, cellulose, SiOx layers, polylactic acid polymers, polyhydroxyalkanoates, hybrid layers of organic polymer and inorganic fibers, layers coated with polyvinyl alcohol or ethylene-vinyl alcohol copolymer, layers metallized preferably with aluminum, the layers of materials being optionally separated by a layer of adhesive, and/or
the seal consists of a multilayer film comprising:
i) a film of paper or filter paper,
ii) a barrier layer, preferably the barrier layer comprising one or a plurality of layers chosen from:
   a hybrid barrier layer comprising an organic polymer and inorganic compounds, and/or
   a SiOx barrier check layer, and/or
   a cellulose barrier layer,
iii) a nonwoven fabric layer, said nonwoven fabric layer being inside the capsule, and/or
   the seal consists of a multilayer consisting of:
i) a barrier layer,
(ii) a film containing biopolymers such as polyhydroxyalkanoates PHA or polybutylenadipate-terephthalate PBAT or polybutylensuccinate PBS or polybutylene-co aliphatic co-terephthalate PBAIT or polylactic acids PLA, Or a multilayer film comprising:
i) a film containing biopolymers such as polyhydroxyalkanoates PHA or polybutylenadipate-terephthalate PBAT or polybutylensuccinate PBS or polybutylene-co aliphatic co-terephthalate PBAIT or polylactic acids PLA,
ii) a barrier layer,
iii) a film containing biopolymers such as polyhydroxyalkanoates PHA or polybutylene co-adipate co-terephthalate PBAT or polybutylene succinate PBS or polybutylene co-aliphatic-co terephthalate PBAIT or polylactic acids PLA.

The invention further relates to the manufacturing method of a capsule according to the invention, said method comprising the steps of:
a) Preparation of the formulation by mixing the ingredients, where, optionally, the ingredients can be extruded,
b) injection molding of the formulation obtained in step a) in a mold so as to form a layer of at least the lateral wall and the circular rim of the container, optionally one or a plurality of layers of the container can be injection molded using a formulation different from the formulation in step a),
c) filling the container with the substance in powder or liquid form, if the bottom is not molded by injection of the formulation, while the filling step is preceded by a step of placing a single-layer or multi-layer bottom to form the container,
d) optionally, closing the container using the seal for forming the capsule,

Or comprising the following steps:
a) Preparation of the formulation by mixing the ingredients, where, optionally, the ingredients can be extruded,
b) Manufacture of plates or of a film by extrusion of the formulation before calendaring or blowing, optionally manufacture of one or a plurality of other layers of at least the side wall and the circular rim of the container by extrusion using at least one formulation different from the formulation in step a), e.g. using a formulation of PVOH or EVOH,
c) Shaping by thermoforming of the plate or film into a suitable shape,
d) filling the container with the substance in powder or liquid form, if the bottom is not shaped by thermoforming during step c), while the filling step is preceded by a step of placing a single-layer or multi-layer bottom to form the container,
e) optionally, closing the container using the seal for forming the capsule.

The capsules according to the invention typically comprise at least 60% by weight of carbon of bio-based origin (also named biocarbon). The concentration of bio-based carbon can be determined as per the standard EN16640. According to said standard, the total carbon fraction of the capsule should be determined, and the bio-based percentage should be measured within the capsule (measurement of C14 by the radiocarbon method).

Advantageously, a capsule according to the invention comprises at least 80% by weight of bio-based carbon, preferably at least 90% by weight of bio-based carbon, relative to the total weight of the carbon atoms of the capsule.

The capsules according to the invention are stable in storage. Since the capsules are well sealed against oxygen and water vapor, same can be stored and preserve the contents for at least 12 months before consumption.

The capsules according to the invention are compatible with Nespresso® machines. The present invention is applicable to other common machine formats.

The capsules according to the invention have a barrier function, i.e. same typically have a permeability to oxygen of less than 3.5×10⁻³ cm³/capsule/24 hrs at 0.21 atm at 23° C. and 50% RH (relative humidity), preferentially equal to or less than 3.0×10⁻³ cm³/capsule/24 hrs at 0.21 atm at 23° C. and 50% RH, further preferentially equal to or less than 2.90×10⁻³ cm³/capsule/24 hrs at 0.21 atm at 23° C. and 50% RH, measured as per the ASTM F1307 standard or as per the ISO 15105-2 standard.

Furthermore, the capsules according to the invention are biodegradable by industrial composting and/or by domestic composting, advantageously same are compostable both by industrial composting and by domestic composting.

Thereby, the capsules according to the invention have both a very satisfactory barrier function against gas, in particular against oxygen, and good mechanical and thermal properties, since the capsules are sufficiently rigid without being brittle while ensuring constant quality during the manufacture and use thereof.

Other features, variants and advantages of the implementation of the invention will become clearer upon reading the following description and the examples, given as an illustration of the invention, but not limited to.

### BRIEF DESCRIPTION OF FIGURES

FIG. 1 is a schematic cross-sectional view of a container implemented according to the invention.

FIG. 2 is a schematic cross-sectional view of a capsule implemented according to the invention.

FIG. 3 is a graph representing the flows of different formulations and polymers as a function of time.

### DETAILED DESCRIPTION OF THE INVENTION

The present invention relates to a sealed capsule in the form of an individual portion containing at least one edible substance in powder or liquid form, for the preparation of a beverage, suitable for being extracted under pressure, the beverage being e.g. coffee, tea, chocolate, lemonade or a dietary supplement.

Preferably, the invention relates to a capsule for preparing a beverage, the capsule including a container including at least one side wall having a circular rim and a bottom. The capsule is intended to be extracted under pressure and contains a substance in powder or liquid form for the preparation of a beverage.

According to one embodiment, the capsule further comprises a seal located opposite the bottom of the capsule.

According to a first variant, the bottom is configured to be perforated by blades of the coffee production machine so that the blades provide openings for the injection of fluid. In such case, the bottom forms an injection wall through which the fluid is injected and the fluid will exit after having passed through the substance contained in the capsule through the seal.

According to a second variant, the blades of the coffee production machine pass through the capsule at the seal which serves herein as an injection wall, and the fluid injected thereinto exits through the bottom.

According to the invention, the sidewall and the circular rim are formed by injection molding or thermoforming of at least one formulation according to the invention.

According to a first embodiment, the side wall, the circular rim and the bottom are formed by injection molding or by thermoforming of at least one formulation according to the invention and the seal is formed by a monolayer or multilayer film.

According to a second embodiment, the bottom and the seal are formed by a monolayer or multilayer film. In such case, during the injection molding or the thermoforming of at least one formulation according to the invention, in addition to the sidewall and the circular rim, a support can also be formed, the support able to be used to support the bottom formed by a monolayer or multilayer film. The support may have e.g. a cross-shaped structure and will then be obtained during the injection molding or the thermoforming of at least one formulation according to the invention.

In the case of a substance in powder form, the extraction of the beverage can be carried out at a pressure ranging from 2 to 20 bar, and e.g. at a temperature ranging from 30 to 100° C.

In the case of a substance in liquid form, the extraction of the beverage can be carried out at a pressure ranging from 2 to 7 bar, and e.g. at room temperature or at a temperature ranging from 20 to 45° C.

According to the invention, the formulation of the capsule comprises:
(i) at least one polymer P1 chosen from PHAs; and
(ii) at least one second polymer P2 chosen from PHAs,
said polymer P1 having a degree of crystallinity (Kc1) greater than or equal to 50% and
said polymer P2 having a degree of crystallinity (Kc2) of less than or equal to 30%, advantageously less than or equal to 15%, even more preferentially less than or equal to 5%.

As described hereinabove, the capsule is typically suitable for being opened on protruding elements under the effect of the pressure rise when a fluid is injected thereinto in a capsule-holder system or, for other systems, for an outlet opening created by mechanical perforation, by spikes, of the membrane or of the bottom.

Preferably, the capsule according to the invention consists of at least 85% by weight of materials that are biodegradable and compostable (aerobic biological process) and/or that can be broken down by anaerobic digestion (anaerobic biological process), preferably 100% of material that are biodegradable and compostable (aerobic biological process) and/or that can be broken down by anaerobic digestion (anaerobic biological process).

“Biodegradable” refers to a material apt to decompose under the action of living organisms, such as bacteria, fungi or algae, in order to convert e.g. into carbon dioxide, water and/or methane.

“Compostable” refers to an object made with a biodegradable material apt to disintegrate under controlled conditions such as e.g. the conditions defined by industrial and domestic compostability standards.

The capsules according to the invention advantageously meet the compostability standard EN 13432, being then called biodegradable under industrial composting conditions.

EN 13432 specifies the technical requirements and procedures for determining the compostability of a material.

EN 13432 defines the characteristics that a material, a product, should have in order to be considered compostable and biodegradable.

Biodegradation can be tested according to standards such as ISO 14855, ISO 17556 or ISO 14851. For example, one of such tests requires that, to be considered “industrially compostable”—at least 90% of the material has to be biologically degraded under controlled conditions within six months.

Similar tests also exist to enable certification of domestic composting. There are currently no international or European standards but only national standards for home composting. Thereby, the capsules according to the invention are biodegradable in domestic composting conditions according to French recommendations. More particularly, same meet the standard NF T51-800 (2015), namely that at least 90% of the capsule is biologically degraded under controlled conditions in less than 365 days (maximum 12 months) at 25° C.+/−5° C. The capsules according to the invention will also typically meet the Australian standard AS 5810 (2010).

The capsule according to the invention thereby typically includes a container and a seal welded onto the circumference of the rim of the container. The container thus comprises a bottom and a side wall with a circular rim. The circular rim holds the capsule when same is inserted into a machine and creates a sealing zone when used in said machine, such as a coffee machine.

The capsule container is typically shaped by one-piece molding or thermoforming of the bottom, of the side wall and of the circular rim, starting from a formulation. The one-piece molding or thermoforming can be carried out in one or a plurality of layers, with the proviso that at least one layer consists of the formulation described in the invention. When two layers are involved, typically each layer will consist of a different formulation. For example, If the molding of the container is produced in two layers, a layer of the formulation according to the invention and a barrier layer consisting e.g. of polyvinyl alcohol (PVOH) or of ethylene-vinyl alcohol (EVOH) can be used.

When three layers are involved, typically, at least two different layers can be used, at least one layer of which will consist of the formulation of the invention. One of the three layers can then be a barrier layer consisting e.g. of PVOH or EVOH.

According to a preferred embodiment, the container is molded in a single layer of the formulation.

According to the invention, the formulation of the capsule comprises:
(i) at least one polymer P1 chosen from PHAs; and
(ii) at least one second polymer P2 chosen from PHAS,
said polymer P1 having a degree of crystallinity (Kc1) greater than or equal to 50% and
said polymer P2 having a degree of crystallinity (Kc2) of less than or equal to 30%, advantageously less than or equal to 15%, even more preferentially less than or equal to 5%.

Consequently, P1 is rather crystalline whereas P2 is rather weakly crystalline or even rather amorphous.

The inventors have thereby discovered that the effectiveness of the oxygen and/or water vapor barrier layer and the flexibility of a capsule result from the nature of the additives as well as from the crystallinity of the polymer used in particular when a polymer of the polyhydroxyalkanoate (PHA) family is involved.

The inventors have discovered that the properties of the capsules are influenced by the degree of crystallization of the formulations thereof. Thereby, the higher the degree of crystallization, the more fragile the molded part will be.

Crystallinity refers to the degree of structural order in a solid and is related to the order of the molecular chains of the polymer.

The degree of crystallinity can be measured by differential thermal analysis or D.T.A. or by differential scanning calorimetry or D.S.C., preferably being measured by D.S.C. The methods serve to determine in particular the glass transition temperature called Tg, the crystallization temperature called Tc and the melting temperature called Tm, of the polymer.

Completely amorphous polymers have neither a crystallization temperature nor a melting temperature, and are thermally characterized by DSC only by the glass transition temperature Tg thereof.

The properties of plastics are strongly influenced by the degree of crystallization thereof. The higher the degree of crystallization, the more rigid a molded part is, but also more fragile. The degree of crystallization (also called crystallinity level) is influenced by the chemical structure and the thermal history, such as cooling conditions during the manufacturing or the post-thermal treatment.

For the determination of the degree of crystallization Kc of the polymer Pi, the enthalpy of melting measured by DSC (ΔHmes) of the polymer Pi is compared with the value in the literature (ΔHlit) for a completely crystalline polymer.

Thereby,

KC=ΔHmes/ΔHlit. [Math 1]

There are databases in the literature, in particular scientific articles describing the enthalpy of fusion of various completely crystalline polymers. Thereby, a person skilled in the art has access to the enthalpy of fusion of completely crystalline polymers, in particular PHA polymers, more particularly PHB polymers.

The enthalpy of fusion ΔHlit of a fully crystalline PHB polymer such as a PHBH or PHBV polymer is 146 J/g as reported in Vorleak Chea et al. J. APPL. POLYM. SCI. 2015, DOI: 10.1002/APP.41850 or in Zonglin Li et al. Polymers 2020, 12, 1300; doi: 10.3390/polymer12061300 or else in Sunny Modi et al. European Polymer Journal 47 (2011) 179-186.

For an amorphous polymer, there is no melting peak, so the enthalpy of melting will be zero. For example, the enthalpy of fusion of a polymer such as P3HB4HB is close to zero.

The degree of crystallinity has a significant influence on hardness, density, transparency and diffusion, hence the barrier properties against gas.

“Polymer” refers, in the present application, to a homopolymer and/or a copolymer.

The polymer P1 is a rather crystalline polymer. The formulation according to the invention may comprise one or a plurality of crystalline polymers P1.

The term “rather crystalline” polymer refers, in the present invention, to a polymer with a degree of crystallinity KC1 greater than or equal to 50%.

The polymer P2 is a weakly crystalline polymer, or even a rather amorphous polymer. The formulation according to the invention may comprise one or a plurality of polymers P2 which are weakly crystalline or even amorphous.

“Weakly crystalline” polymer as defined by the present invention, refers to a polymer that has a degree of crystallinity Kc2 ranging from 5% to 49%.

“Rather amorphous” polymer, as defined by the present invention, refers to a polymer that has a degree of crystallinity Kc2 of less than or equal to 5%.

The rather crystalline polymer P1 has a melting temperature. When the polymer P2 is amorphous, same has no melting point.

According to one embodiment, the glass transition temperature Tg of the crystalline polymers P1 used in the invention is greater than −10° C., preferably ranges from −5 to 5° C. (measured by DSC with a temperature ramp of +10° C./min).

According to one embodiment, the glass transition temperature Tg of the amorphous polymers P2 used in the invention is less than −10° C., preferably ranges from −20° C. to −10° C. (measured by DSC with a temperature ramp of +10° C./min).

According to one embodiment, the melting temperature of the crystalline polymers P1 used according to the invention ranges from 120° C. to 200° C. (measured by DSC with a temperature ramp of +10° C./min).

According to one embodiment of the invention, the formulation comprises silica (SiO₂) and/or titanium dioxide (TiO₂). SiO₂ and/or TiO₂ play a role in the barrier function but also are nucleating agents. Silica (SiO₂) has a particle size strictly greater than 100 nm, more preferentially strictly less than 500 nm. The TiO₂ has a particle size strictly greater than 460 nm, more preferentially strictly greater than 460 nm and strictly less than 3900 nm.

“Particle size” refers to the median diameter measured e.g. by laser particle size distribution.

Typically, all ingredients in the formulation are biodegradable.

According to one embodiment, the PHAs are chosen from the family of PHBs (poly (hydroxybutyrate)).

Within the framework of the present invention, a “polymer of the PHB family” refers to a polymer including at least one repeat unit of formula —(O—CH(CH₃)—CH₂CO)—.

According to one embodiment, the PHAs are chosen from poly3-hydroxybutyrate-co-3-hydroxyhexanoate polymers (PHBH), polyhydroxybutyrate/hydroxyvalerate polymers (PHBV) poly3-hydroxybutyrate 4-hydroxybutyrate (P3HB4HB) polymers, and mixtures thereof.

The polymer PHBH includes 3-hydroxybutyrate (3HB) monomer units and 3-hydroxyhexanoate (3HH) monomer units.

The 3HB monomer unit has the formula (1):

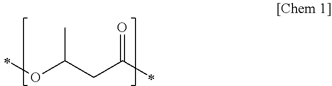

The 3HH monomer unit has the formula (2):

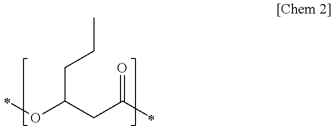

The PHBV polymer includes 3-hydroxybutyrate (3HB) monomer units and hydroxyvalerate (HV) monomer units.

The HV monomer unit has the formula (3):

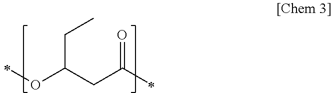

The polymer P3HB4HB includes 3-hydroxybutyrate (3HB) monomer units and 4-hydroxybutyrate (4HB) monomer units.

The 4HB monomer unit has the formula (4):

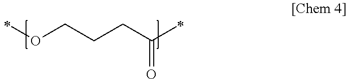

Preferably, in the formulation according to the invention, the polymer PHBV, when present, is a rather crystalline polymer and the polymers PHBH and P3HB4HB, when present, are weakly crystalline or even amorphous polymers.

According to one embodiment, the polymer P1 is a polymer obtained by aerobic and/or anaerobic fermentative engineering of bio-based material.

According to one embodiment, the polymer P1 contains monomer units M1a of hydroxybutyrates 3HB and monomer units M1b chosen from either hydroxyvalerate HV or 3-hydroxyhexanoate HH or 4-hydroxybutyrate 4HB, M1a being different from M1b.

Preferably, the monomer units M1b represent less than 5% by weight, preferably less than 3% by weight, or even less than 1% by weight, of the total weight of the monomer units M1a and M1b.

According to one embodiment, the polymer P2 is a polymer obtained by aerobic and/or anaerobic fermentative engineering of bio-based material.

According to one embodiment, the polymer P2 contains monomer units M2a of hydroxybutyrates 3HB and monomer units M2b chosen from either hydroxyvalerate HV or 3-hydroxyhexanoate HH or 4-hydroxybutyrate 4HB, M2a being different from M2b.

Preferably, the monomer units M2b represent at least 5% by weight, preferably at least 20% by weight, even at least 30% by weight, of the total weight of the monomer units M2a and M2b.

According to one embodiment, the weight ratio M1b/M1a is less than or equal to 0.07, preferably less than or equal to 0.6 and/or the weight ratio M2b/M2a is greater than or equal to 0.05, preferably ranges from 0.1 to 1, else preferably from 0.2 to 0.9.

Preferably, the polymers P1 and P2 do not comprise monomer units different from PHAs, preferably the polymers P1 and P2 do not comprise monomer units different from monomer units coming from M1A, M1b, M2a and M2b, respectively.

The polymers P1 and P2 are commercially available or can be prepared according to methods known to a person skilled in the art.

According to such embodiment, said additive or additives represent from 70 to 99% by weight, preferably from 80 to 98% by weight, preferably 85 to 97% by weight, of the total weight of the polymers P1 and P2.

According to such embodiment, said additive or additives represent from 1 to 30% by weight, preferably from 2 to 20% by weight, preferably 3 to 15% by weight, of the total weight of the polymers P2 and P2.

According to one embodiment, the formulation comprises from 50 to 99.9% by weight, preferably from 75 to 99.5% by weight, advantageously from 90 to 99% by weight, of polymer(s) P1 and P2, relative to the total weight of the formulation, P1 and P2 being preferably chosen from PHBV polymers and P3HB4HB polymers, the PHBV polymer preferably being a crystalline polymer and the P3HB4BH polymer preferably being an amorphous polymer.

According to one embodiment, the formulation further comprises (iii) at least one inorganic or organic filler, preferably chosen from silica, silicates, vitamins (preferably vitamin E), peroxides, vegetable or animal waxes, plasticized animal or vegetable proteins, or mixtures thereof, preferably among silica, silicates, vitamin E, plasticized animal or vegetable proteins, or mixtures thereof.

The inorganic or organic fillers can represent e.g. represent from 0.5 to 25% by weight, advantageously from 1 to 15% by weight, of the total weight of the formulation.

According to one embodiment, the silicates are chosen from aluminum silicates, aluminum and magnesium silicates, preferentially amongst aluminum silicates or else LDH (Layered Double Hydroxides).

Aluminum and magnesium silicates include montmorillonites.

According to one embodiment, the silicates are chosen from phyllosilicates, preferentially aluminum phyllosilicates.

According to one embodiment, the phyllosilicates are chosen from kaolinites, halloysites and mixtures thereof.

According to one embodiment, aluminum silicates are kaolins.

According to one embodiment, the silicates, preferentially aluminum silicates, have a particle size with a median diameter measured by laser particle size analysis ranging from 0.5 μm to 20 μm, and/or a specific surface area (measured by the BET (Brunauer, Emmett et Teller) method) ranging from 1 to 250 m²/g.

Typically, such silicates have dimensional shape factors greater than or equal to 1:2, advantageously greater than or equal to 1:4, and particularly greater than or equal to 1:6, referred to as silicates with an acicular shape. The shape factor can be determined by microscopy, e.g. by scanning electron microscopy (SEM). The acicular fillers are oriented preferentially during the injection of the capsule along the direction of flow and hence parallel to the surface of the walls of the capsule and serve for:
a mechanical reinforcement along the long direction (less crushing of the capsule), and
an increase in the tortuosity of the polymer matrix provided by the presence of particles with acicular shape providing an additional barrier

According to one embodiment, the silicates, typically having an acicular shape, will have one or even two nanometric dimensions (from 1 nm to 100 nm), with the proviso that the silicates comprise at least one micrometric dimension (from 1 μm to less than 1 mm), so as to meet the standards on food contact. Such nano/micro dimensioning can be used for introducing a smaller quantity of silicates, compared to a micrometric carbonate or talc, and has at least 2 advantages:
a lightening the weight of the finished part, while improving the barrier effect against O₂ of the material
an increase in the stress resistance of the capsule as well as the Young's modulus.

According to one embodiment, the formulation comprises:
from 50 to 99.9% by weight, preferentially from 75 to 99.5% by weight, advantageously from 90 to 99% by weight, of polymer(s) P1 and P2,
from 0.1 to 50% by weight, preferentially from 0.5 to 25% by weight, more preferentially from 1 to 15% by weight, of ingredient(s) chosen from silicates, vitamin E, plasticized proteins of either animal or plant origin and mixtures thereof,

with respect to the total weight of the formulation.

According to one embodiment, the formulation comprises:
from 50 to 99.9% by weight, preferentially from 75 to 99.5% by weight, advantageously from 90 to 99% by weight, of polymer(s) P1 and P2,
from 0.1 to 50% by weight, preferentially from 0.5 to 25% by weight and advantageously from 1 to 15% by weight, of ingredient(s) chosen from silicates, vitamin E, and mixtures thereof

with respect to the total weight of the formulation.

According to one embodiment, the formulation comprises:
(i) from 50 to 98% by weight, preferentially from 75 to 95% by weight, advantageously from 80 to 90% by weight, of polymer(s) P1,
(ii) from 0.5 to 20% by weight, preferentially from 1 to 15% by weight, advantageously from 2 to 10% by weight, of polymer(s) P2,
(iii) from 0.1 to 50% by weight, preferentially from 0.5 to 25% by weight, advantageously from 1 to 15% by weight, of inorganic or organic fillers,
with respect to the total weight of the formulation.

According to one embodiment, the formulation comprises:
(i) from 50 to 98% by weight, preferably from 75 to 95% by weight, advantageously from 80 to 90% by weight, of polymer(s) P1, P1 including monomer units Mia of hydroxybutyrates 3HB and monomer units M1b chosen from either hydroxyvalerate (HV) or 3-hydroxyhexanoate (HH) or either 4-hydroxybutyrate (4HB),
(ii) From 0.5 to 20% by weight, preferably from 1 to 15% by weight, advantageously from 2 to 10% by weight, of polymer(s) P2, P2 including monomer units M2a of hydroxybutyrate (3HB) and monomer units M2b chosen from either hydroxyvalerate (HV) or 3-hydroxyhexanoate (HH) or either 4-hydroxybutyrate (4HB),
(iii) from 0.1 to 50% by weight, preferentially from 0.5 to 25% by weight, advantageously from 1 to 15% by weight, of inorganic or organic fillers,
with respect to the total weight of the formulation,
P1 and P2 being advantageously obtained by aerobic and/or anaerobic fermentative engineering of bio-based material.

According to one embodiment, the formulation comprises:
(i) from 50 to 98% by weight, preferentially from 75 to 95% by weight, advantageously from 80 to 90% by weight, of polymer(s) P1,
(ii) from 0.5 to 20% by weight, preferentially from 1 to 15% by weight, advantageously from 2 to 10% by weight, of polymer(s) P2,
(iii) from 0.1 to 50% by weight, preferentially from 0.5 to 25% by weight and advantageously from 1 to 15% by weight, of inorganic or organic fillers chosen from silicates, vitamin E, and mixtures thereof
with respect to the total weight of the formulation.

According to one embodiment, the formulation comprises, with respect to the total weight of the formulation:
(i) from 50 to 98% by weight, preferably from 75 to 95% by weight, advantageously from 80 to 90% by weight, of polymer(s) P1, P1 including monomer units Ma of hydroxybutyrates 3HB and monomer units M1b chosen from hydroxyvalerate (HV), 3-hydroxyhexanoate (HH) or 4-hydroxybutyrate (4HB), the monomer M1b being less than 5% by weight, preferably less than 3% by weight or even less than 1% by weight, of the total weight of the monomers M1a and M1b,
(ii) from 0.5 to 20% by weight, preferably from 1 to 15% by weight, advantageously from 2 to 10% by weight, of polymer(s) P2, P2 including monomer units M2a of hydroxybutyrate (3HB) and monomer units M2b chosen from either hydroxyvalerate (HV) or 3-hydroxyhexanoate (HH) or 4-hydroxybutyrate (4HB), the monomer M2b representing at least 5% by weight, preferably at least 20% by weight or even at least 30% by weight, of the total weight of the monomers M2a and M2b,
(iii) from 0.1 to 50% by weight, preferably from 0.5 to 25% by weight and advantageously from 1 to 15% by weight, of organic or inorganic fillers chosen from silicates, vitamin E, and mixtures thereof,
P1 and P2 being advantageously obtained by aerobic and/or anaerobic fermentative engineering of bio-based material.

According to one embodiment, the formulation comprises, with respect to the total weight of the formulation:
(i) from 50 to 98% by weight, preferably from 75 to 95% by weight, advantageously from 80 to 90% by weight, of polymer(s) P1, P1 including monomer units M1a of hydroxybutyrates 3HB and monomer units M1b chosen from hydroxyvalerate (HV), 3-hydroxyhexanoate (HH) or 4-hydroxybutyrate (4HB), the monomer M1b being less than 5% by weight, preferably less than 3% by weight or even less than 1% by weight, of the total weight of the monomers M1a and M1b,
(ii) from 0.5 to 20% by weight, preferably from 1 to 15% by weight, advantageously from 2 to 10% by weight, of polymer(s) P2, P2 including monomer units M2a of hydroxybutyrate (3HB) and monomer units M2b chosen from either hydroxyvalerate (HV) or 3-hydroxyhexanoate (HH) or 4-hydroxybutyrate (4HB), the monomer M2b representing at least 5% by weight, preferably at least 20% by weight or even at least 30% by weight, of the total weight of the monomers M2a and M2b,
(iii) from 0.1 to 50% by weight, preferentially from 0.5 to 25% by weight, advantageously from 1 to 15% by weight, of aluminum silicates,
with respect to the total weight of the formulation,
P1 and P2 being advantageously obtained by aerobic and/or anaerobic fermentative engineering of bio-based material.

According to one embodiment, the formulation comprises:
from 50 to 98.9% by weight, preferably from 75 to 97.5% by weight, advantageously from 80 to 94% by weight, of polymer(s) chosen from PHBV polymers and P3HB4HB polymers, the PHBV polymer being a rather crystalline polymer and the P3HB4BH polymer being a rather amorphous polymer,
from 0.1 to 40% by weight, preferentially from 0.5 to 25% by weight, more preferentially from 1 to 15% by weight, of ingredient(s) chosen from silicates, aluminum, plasticized proteins of either animal or plant origin, vitamin E, or mixtures thereof, optionally from 1 to 30% by weight, preferably from 2 to 20% by weight, advantageously from 5 to 10% by weight, of PVOH or EVOH, relative to the total weight of the formulation,
P1 and P2 being advantageously obtained by aerobic and/or anaerobic fermentative engineering of bio-based material.

According to one embodiment, the formulation comprises:
from 50 to 98.9% by weight, preferably from 75 to 97.5% by weight, advantageously from 80 to 94% by weight, of polymer(s) chosen from PHBVs and P3HB4HBs, the PHBV polymer being a rather crystalline polymer and the P3HB4BH polymer being a rather amorphous polymer, from 0.1 to 40% by weight, preferentially from 0.5 to 25% by weight, advantageously from 1 to 15% by weight, of aluminum silicates, optionally from 1 to 30% by weight, preferably from 2 to 20% by weight, advantageously from 5 to 10% by weight, of PVOH or EVOH,
with respect to the total weight of the formulation,
P1 and P2 being advantageously obtained by aerobic and/or anaerobic fermentative engineering of bio-based material.

When the formulation comprises a mineral or organic filler chosen from silica, silicates, vitamin E or a plasticized animal or vegetable protein, the formulation may further comprise, optionally, one or a plurality of additives chosen from mineral fillers other than silicates, peroxide-type products, vitamins different from vitamin E, vegetable or animal waxes. According to such embodiment, said additive or additives may represent from 0.05 to 20% by weight, preferentially from 0.1 to 15% by weight, advantageously from 1 to 10% by weight, of the total weight of the formulation.

Preferably, the formulation consists entirely of materials that are biodegradable and compostable (aerobic biological process) and/or that can be broken down by anaerobic digestion (anaerobic biological process).

The formulation implemented in the invention is typically produced by extrusion, preferentially by twin-screw extrusion. A formulation in the form of granules can then be obtained.

Typically, the capsule is as per the standard EN 13432 in vigor since 2002.

Anaerobic digestion is a technology based on the degradation by microorganisms of organic matter, under controlled conditions and in the absence of oxygen, hence in anaerobic environment, unlike composting, which is an aerobic reaction.

Typically, during the use thereof, the capsule containing at least one substance in powder or liquid form for the preparation of a beverage is inserted into a capsule-holder of a beverage preparation machine, before closing the capsule-holder and starting the preparation of the beverage.

The capsule contains a substance in powder or liquid form for the preparation of a drink. The drink will preferentially be coffee, tea, a chocolatey product, preferentially coffee. The substance in the form of a powder, for preparing coffee, can be roasted and ground coffee, soluble coffee or a mixture thereof.

The capsule according to the invention can be prepared according to the following method:
a) preparation of the formulation by mixing the ingredients, where said ingredients may optionally be extruded;
b) injection molding of the formulation in a mold so as to form a layer of at least the side wall and the circular rim of the container, preferably of the bottom, of the side wall and of the circular rim of the container, and optionally, one or a plurality of other layers of the container can be injection molded, typically using at least one formulation different from the formulation used in step a), e.g. using a PVOH or EVOH formulation,
c) optionally, filling the container with the substance in powder or liquid form, if the bottom is not injection molded with the formulation, while the filling step is preceded by a step of placing a bottom of the monolayer or multilayer type in order to form a container,
d) optionally, closing the container with the seal so as to form the capsule.

Alternatively, the capsule according to the invention can be prepared by the following method:
a) preparation of the formulation by mixing the ingredients, where said ingredients may optionally be extruded;
b) manufacture of plates or film by extrusion of the formulation before calendaring or blowing, optionally manufacture of one or a plurality of other layers of at least the side wall and the circular rim of the container by extrusion using at least one formulation different from the formulation in step a), e.g. using a formulation of PVOH or EVOH,
c) shaping at least the sidewall and the circular rim of the container by thermoforming the plate onto or into a suitable shape
d) optionally, filling the container with the substance in powder or liquid form, if the bottom is not manufactured by thermoforming during step c), while the filling step is preceded by a step of placing a bottom of the monolayer or multilayer type in order to form a container,
e) optionally, closing the container using the seal for forming the capsule.

Preferably, the preparation method comprises only one step of injection molding or thermoforming using the formulation defined in the invention. The container according to the invention will then, according to the above embodiment, consist of only one layer with the formulation defined in the invention.

The container generally has a thickness ranging from 0.2 to 1 mm, preferably from 0.3 to 0.8 mm. The bottom of the container is apt to be perforated and may optionally comprise a recess.

The circular rim is formed during the production of the container by thermoplastic injection into a mold having the appropriate shape. Said circular rim can have a width ranging from 1 to 4 mm. The main function of the circular rim is to abut against an edge of a capsule holder of the beverage making apparatus during the phase of extracting the beverage, e.g. coffee, and thus to allow the capsule to be held firmly during the rise in pressure.

The mold for injection or the mold for thermoforming will thereby typically comprise a bottom or a support, a side wall and a circular rim, in order to obtain each of the layers of the container, preferably the container will consist of a single layer of the formulation according to the invention.

According to a first embodiment, the side wall, the circular rim and the bottom are formed by injection molding or by thermoforming of at least one formulation according to the invention and the seal is formed by a monolayer or multilayer film. According to the first embodiment, the mold will comprise a bottom, a side wall and a circular rim.

According to a second embodiment, a support, the side wall and the circular rim are formed by injection molding or by thermoforming of at least one formulation according to the invention and the seal and the bottom are formed by a monolayer or multilayer film. According to the second embodiment, the mold will comprise a support (e.g. in the form of a cross), a side wall and a circular rim.

The seal typically has a size calibrated so as to match the contour of the circular rim of the capsule container, thus closing the container.

The substance in powder form, preferably ground coffee, is thus trapped inside the hollow container. Typically, the seal will be bonded or heat-welded to the circular rim of the capsule container.

According to one embodiment, the seal consists of a biodegradable and compostable film (aerobic biological process) and/or of a film which can be broken down by anaerobic digestion (anaerobic biological process). Typically, the seal can be either a monolayer or a multilayer film with a total thickness ranging from 90 to 300 μm.

The seal can thereby consist of one or a plurality of layers of materials chosen from paper, nonwoven fabrics, cellulose, barrier layers, where the layers of materials can be separated by a layer of adhesive, which would as such be biodegradable and compostable (aerobic biological process) and/or can be broken down by anaerobic digestion (anaerobic biological process).

Nonwoven fabrics include polylactic acid (PLA) or the non-woven fabrics polyhydroxyalkanoate nonwoven fabrics (PHA) or polybutylensuccinate (PBS) or polybutylenadipat-terephthalate (PBAT) or polybutylene adipate-co-terephthalate (PBAIT), where the aliphatic di-acid may be e.g. the sebacic acid.

Barrier layers include SiOx or Al₂O₃ layers, PLA layers, organic polymer and inorganic fiber hybrid layers, layers coated with PVOH (polyvinyl alcohol) or EVOH (ethylene-vinyl alcohol copolymer), layers metallized e.g. with aluminum, and barrier layers produced by vaporization (plasma or air vacuum deposition).

“Barrier” refers to the ability of a material to limit or to reduce the passage of oxygen and/or water vapor or moisture, and can then be referred to as a barrier layer to oxygen and/or moisture. Hybrid layers of organic polymer and inorganic compounds include layers comprising silicic acid polycondensates modified by organic groups and inorganic compounds. Organic groups include polycaprolactone, chitosan and celluloses. The silicic acid polycondensate contains Si—O—Si bonds. Inorganic compounds include silicon cations optionally in combination with other cations such as aluminum, titanium, boron or zirconium.

Examples of the production of the seal include:
a seal consisting of:
   i) a film containing greaseproof paper or filter paper
   ii) an adhesive layer and/or a barrier layer,
   (iii) a nonwoven fabric layer,
   once implemented in the capsule, the layer i) is the outer layer and the layer iii) is the layer inside the capsule;
a seal consisting of:
   i) a filter paper film,
   ii) a barrier layer,
   iii) a barrier film such as a cellulose film or PLA film or PHA film,
   iv) a layer of nonwoven fabric,
   once implemented in the capsule, the layer i) is the outer layer and the layer iv) is the layer inside the capsule;
a seal consisting of:
   i) a cellulose film or an cellulose film, such as Naturflex®,
   ii) a layer of nonwoven fabric,
   once implemented in the capsule, the layer i) is the outer layer and the layer ii) is the layer inside the capsule;
a seal consisting of:
   i) a paper film or filter paper film,
   ii) a hybrid barrier layer of organic polymer and inorganic compounds,
   iii) a SiOx or Al₂O₃ barrier layer,
   iv) a cellulose barrier film,
   v) a nonwoven fabric layer,
once implemented in the capsule, the layer i) is the outer layer and the layer iv) is the layer inside the capsule;
a seal consisting of:
   (i) a film based on a biopolymer such as PHA or PBAT or PBS or polybutylene-co aliphatic co terephthalate (PBAIT), where the aliphatic diacid may be e.g. sebacic acid or else PLA,
   ii) a barrier layer,
   iii) a biopolymer film such as PHA or PBAT or PBS or PBAIT or else PLA,
   once implemented in the capsule, the layer i) is the outer layer and the layer iii) is the layer inside the capsule;
a seal consisting of:
   i) a barrier layer,
   ( ) a biopolymer film such as PHA or PBAT or PBS or polybutylene-co aliphatic co terephthalate (PBAIT), where the aliphatic diacid may be e.g. sebacic acid or else PLA,
   once implemented in the capsule, the layer i) is the outer layer and the layer ii) is the layer inside the capsule.

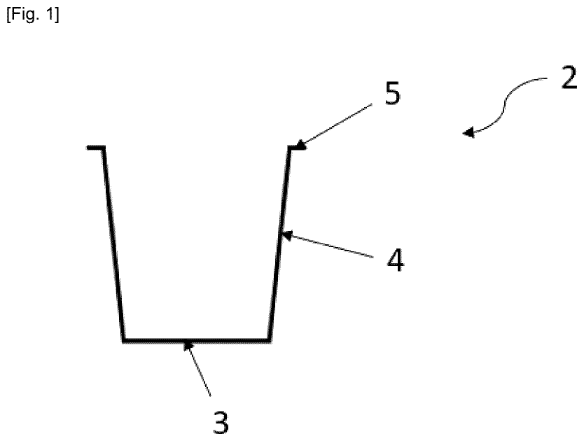

Referring to FIG. 1, a container 2 according to the invention consists of a bottom 3 with a substantially circular shape and of a side wall 4 provided with a circular rim 5.

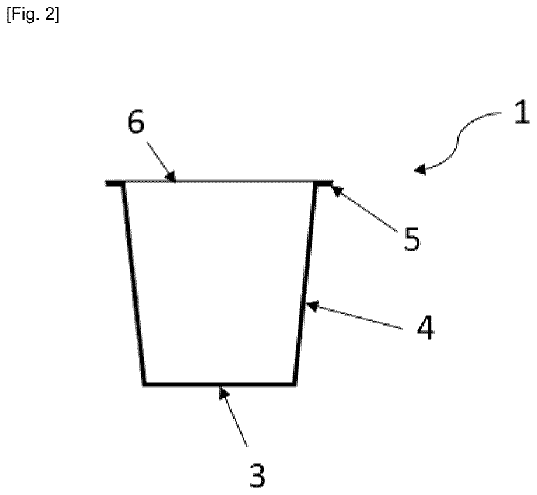

Referring to FIG. 2, the capsule 1 according to the invention comprises a container and a seal 6. The container consists of a bottom 3 with a substantially circular shape and of a side wall 4 provided with a circular rim 5. The capsule according to the invention further comprises a substance in powder or liquid form, for the preparation of a drink (fed in before closing the capsule with the seal) which has not been shown in FIG. 2.

The invention further relates to a manufacturing method for a capsule according to the invention.

According to a first embodiment, the method according to the invention comprises the steps of:
a) Preparation of the formulation by mixing the ingredients, where, optionally, the ingredients may be extruded,
b) Injection molding of the formulation in a mold so as to form a layer of the at least the side wall and the circular rim of the container, optionally manufacturing of one or a plurality of other layers of at least the side wall and the circular rim of the container by extrusion using at least one formulation different from the formulation used in step a), e.g. using a PVOH or EVOH formulation,
c) optionally, filling the chamber with the substance in powder form,
d) optionally, closing the container using the seal for forming the capsule.

When the bottom is not a monolayer or multilayer film, step b) of the manufacturing method preferably comprises a step of injection molding of the formulation in a mold to form a layer of the container including a bottom, a side wall and a circular rim.

When the bottom is not a monolayer or multilayer film, step b) of the manufacturing method preferably comprises a step of injection molding of the formulation in a mold to form a layer of the container including a support (e.g. a cross-shaped structure), a side wall and a circular rim.

Alternatively, the method according to the invention comprises the steps of:
a) Preparation of the formulation by mixing the ingredients, where, optionally, the ingredients may be extruded,
b) manufacture of plates or film by extrusion of the formulation before calendaring or blowing, optionally manufacture of one or a plurality of other layers of the container by extrusion using at least one formulation different from the formulation in step a), e.g. using a formulation of PVOH or EVOH,
c) shaping the container by thermoforming the plate onto or into a suitable shape,
d) optionally, filling the container with the substance in powder or liquid form,
e) optionally, closing the container using the seal for forming the capsule.

Preferably, the preparation method comprises only one step of injection molding or thermoforming using the formulation defined in the invention. The container according to the invention will then, according to said embodiment, consist of only one layer with the formulation defined in the invention.

Finally, the invention relates to the use of a formulation as defined in the present invention for preparing a capsule having a low permeability to gas and moisture.

Typically, the container according to the invention has a permeability to oxygen of less than 3.5×10⁻³ cm³/capsule/24 hrs at 0.21 atm at 23° C. and 50% RH (relative humidity), preferentially equal to or less than 3.0×10⁻³ cm³/capsule/24 hrs at 0.21 atm at 23° C. and 50% RH, further preferentially equal to or less than 2.90×10⁻³ cm³/capsule/24 hrs at 0.21 atm at 23° C. and 50% RH, measured as per the ASTM F1307 standard or as per the ISO 15105-2 standard. During the permeability measurement test, the container is fastened onto a plate, so that the plate “closes” the container.

Advantageously, the capsule according to the invention has one or a plurality of the following characteristics:
a maximum stress of at least 35 MPa, preferably ranging from 35 to 65 MPa, more preferentially from 39 to 60 MPa; and/or
a Young's modulus of at least 900 MPa, preferably ranging from 1000 to 2400 MPa, more preferentially from 1050 to 2100 MPa; and/or
an elongation at maximum stress of less than or equal to 8%, preferably ranging from 2 to 8%, more preferentially from 2.5 to 7%; and/or
a tensile stress of 25 to 80 MPa, preferably 35 to 70 MPa, more preferentially from 40 à 65 MPa; and/or
an elongation at break from 1 to 15%, preferably 2 to 10%, more preferentially from 2.5 to 8%; and/or
a Charpy Impact Strength ranging from 2 to 20 KJ/m², preferably from 3 to 15 KJ/m², more preferentially from 4 to 10 KJ/m².

Such characteristics can be measured as per the methods described in the experimental part.

For example, the maximum stress, Young's modulus, the elongation at maximum stress, the breaking stress and the elongation at break are measured under bending according to the standard NF EN ISO 178 at a speed of 10 mm/min and advantageously at a temperature comprised between 2° and 23° C. and a relative humidity between 45 and 55%.

The Charpy Impact Strength can be measured according to the standard NF ISO 179 advantageously at a temperature between 2° and 23° C. and a relative humidity between 45 and 55%.

### EXAMPLES

The examples below illustrate work, not exhaustive, undertaken by the Applicant.

### Example 1: Determination of the Crystallinity Degrees of the Polymers P1 and P2

Different polymers of the PHA family have been sourced from several producers. DSC analyses were performed on TA instruments DSC 2920 equipment (heating rate: +/−10° C./min; weight of the sample approximately 20 mg.

Table 1 below presents the results of thermal analyses, including the temperatures of melting (Tm), of crystallization (Tc_n), of cold crystallization (Tcc), of enthalpy of melting (ΔHM1), and the crystallinity degree (Kc) of said polymers (with an enthalpy of melting from the literature fusion for the fully crystalline PHA ΔH^{°b 100%}ₘ, PHA=146.6 J/g).

TABLE 1

| | Tc_n | Tm | ΔHm1 | Tcc | Kc |
|---|---|---|---|---|---|
| | (° C.) | (° C.) | (J/g) | (°C) | (%) |
| PHBV 10 | 123 | 174 | 83.0 | — | 57% |
| PHBH 12 | 62.1 | 160 | 23.5 | — | 16% |
| PHBH 13 | 65 | 144 | 36.8 | — | 25% |
| PHBH 15 | 44 | 107; 125; | 14.3 | 57 | 10% |
| | | 163 | | | |
| P3HB4HB 00 | 49 | 85 | 0.29 | / | 0.2% |

The characterizations make it possible to classify the polymers according to the degree of crystallinity thereof and thus they make it possible to classify the polymers according to the nomenclature P1 (rather crystalline) or P2 (weakly crystalline or amorphous).

### Example 2 Formulations Based on Polymers P1, P2 and Other Additives-Impact on Mechanical Properties

The applicant has produced a plurality of formulations by extrusion, listed in Table 2 below, wherein the % are % by weight:

TABLE 2

| Formulation | composition |
|---|---|
| F89 | 80% PHBV 10 + 20% Kaolin |
| F90 | 72% PHBV 10 + 25% Kaolin + 3% Triethyl citrate |
| F91 | 90% PHBV 10 + 5% P3HB4HB 00 + 5% Kaolin |
| F92 | 85% PHBV 10 + 5% P3HB4HB 00 + 10% Kaolin |
| F93 | 80% PHBV 10 + 20% F89 |
| F94 | 90% (80% PHBV 10 + 20% F89) + 10% P3HB4HB 00 |

Formulations F89, F90 and F93 are comparative formulations while formulations F91, F92 and F94 are according to the invention.

Impact and bending test pieces (Dimension: L=78 mm; L=10 mm and EP-4 mm) were produced on a DK 25T press from said formulations. In addition, certain polymers P1 and P2 were injected.

Table 3 below presents the mechanical properties under bending according to the standard NF EN ISO 178, measured on an Adamel Lhomargy dynamometer with a 500 N force sensor, at a deformation rate of 10 mm/min.

The measurements were carried out at a temperature between 2° and 23° C. and a relative humidity between 45 and 55%.

“Max stress (MPa) refers to the maximum stress.

“Elongation at max. stress” refers to the elongation at maximum stress.

“Break stress” refers to the ultimate stress.

The samples tested are the polymers of Table 1 and the formulations of Table 2.

TABLE 3

| | | Cont. | Youngs's | Elongation | Break | Elongation |
|---|---|---|---|---|---|---|
| | Number | Max | modulus | at max. | stress | at break |
| Sample | of tests | (MPa) | (MPa) | stress (%) | (MPa) | (%) |
| PHBH 12 | 5 | 12 ± 0.65 | 204 ± 37 | 9.23 ± 0.57 | / | / |
| PHBH 13 | 4 | 36 ± 1.95 | 529 ± 43 | 10.18 ± 0.26 | / | / |
| PHBH 15 | 3 | 24 ± 0.47 | 280 ± 6 | 10.68 ± 0.15 | / | / |
| PHBV 10 | 4 | 48 ± 3.54 | 1015 ± 110.00 | 4.89 ± 0.67 | 46 ± 3.39 | 5.01 ± 0.71 |
| F89 | 5 | 52 ± 6.01 | 1798 ± 133 | 2.62 ± 0.34 | 51 ± 5.94 | 2.63 ± 0.35 |
| F90 | 5 | 44 ± 4.69 | 1737 ± 275 | 2.50 ± 0.30 | 43 ± 4.51 | 2.53 ± 0.31 |
| F91 | 5 | 55 ± 3.80 | 1408 ± 157 | 4.37 ± 0.55 | 53 ± 3.63 | 4.56 ± 0.64 |
| F92 | 5 | 55 ± 1.71 | 1378 ± 176 | 4.84 ± 0.41 | 53 ± 2.49 | 5.06 ± 0.57 |
| F93 | 5 | 53 ± 5.75 | 1728 ± 173 | 3.51 ± 0.66 | 52 ± 5.55 | 3.57 ± 0.69 |
| F94 | 5 | 49 ± 1.46 | 1142 ± 81 | 6.06 ± 0.88 | 47 ± 1.72 | 6.40 ± 1.11 |

The formulations according to the invention have a Young's modulus on the order of 1000 to 1410 MPa. The above shows that the formulation according to the invention is not very rigid compared to comparative formulations or even polymers, which gives same a flexibility sought in the field.

As for the elongation at break, which defines the capacity of a material to elongate before breaking when stressed under tension or bending, the results obtained with the formulations according to the invention, on the order of 5 to 7%, show a better ability of the mixtures to deform before breaking.

Table 4 below gives the results of Charpy Impact Strength (A_{cu}) measured according to the standard NF ISO 179. The measurements are carried out at a temperature between 2° and 23° C. and a relative humidity between 45 and 55%.

TABLE 4

| | A_{cu} Impact |
|---|---|
| | Strength |
| | [kJ/m²] |
| PHBH 12 | 27.4 +/− 2.7 |
| PHBH 13 | 35.5 +/− 2.8 |
| PHBH 15 | 46.7 +/− 1.7 |
| PHBV 10 | 4.2 +/− 1.1 |
| F89 | 3.4 +/− 0.6 |
| F90 | 5.8 +/− 2.1 |
| F91 | 7.8 +/− 0.9 |
| F92 | 7.6 +/− 1.0 |
| F93 | 4.4 +/− 1.3 |
| F94 | 8.7 +/− 0.7 |

For polymers, PHBH 12 and PHBV 15 showed no impact breakage, whereas complete breakage occurred for PHBH 13 and PHBV 10.

In addition, the formulations according to the invention show a certain flexibility compared to formulations not comprising a P2 polymer. Indeed, the examples in Table 4 illustrate the interest of the invention: the results obtained for the comparative formulations F89, F90 and F93, containing no P2 polymer (rather weakly crystalline or rather amorphous) show that the formulations are too fragile, whereas the formulations F91, F92 and F94, according to the invention, allow better properties to be obtained. Indeed, the incorporation of P2 polymers serves to bring flexibility and impact strength to the final composition, generating a good functionality of use of the capsules.

Tables 3 and 4 show that the capsules according to the invention have a better impact strength and a better elongation at break than the formulations which are not according to the invention, impact strength and elongation at break being important factors influencing the fragility of the capsule during the manufacturing line or during the use thereof.

The applicant also measured the thermal properties of the formulations. Table 5 below presents the crystallinity degrees of formulations F90 to F94, according to the same modalities as for polymers P1 and P2 (of example 1).

TABLE 5

| | Tc_n | Tm | ΔHm1 | Kc1 |
|---|---|---|---|---|
| | (° C.) | (° C.) | (J/g) | (%) |
| F90 | 120 | 171 | 83.3 | 79% |
| F91 | 124 | 174 | 87.7 | 67% |
| F92 | 125 | 174 | 85.3 | 69% |
| F93 | 127 | 174 | 107.5 | 77% |
| F94 | 124 | 174 | 79.5 | 63% |

The results obtained according to Table 5 show that the incorporation of P2 polymers serves to improve the mechanical properties, in particular the impact resistance.

### Example 3: Impact on Rheological Properties and Thermal Stability

Plastics processing processes for the use and shaping of polymers produce significant shear rates, around 104 sec⁻¹ for extrusion and injection, which induces reductions in molecular weight by chain breaking, and hence loss of performance. The same applies to thermal stress which causes chain breaks by thermo-oxidation.

The Applicant carried out thermal stability studies on certain polymers and certain formulations to measure the impact of adding P2 polymers to P1 type polymers.

The characterizations were carried out with a plastometer: temperature of 183° C.; load of 2.16 kg; all the materials baked at 80° C. for 2 hours.

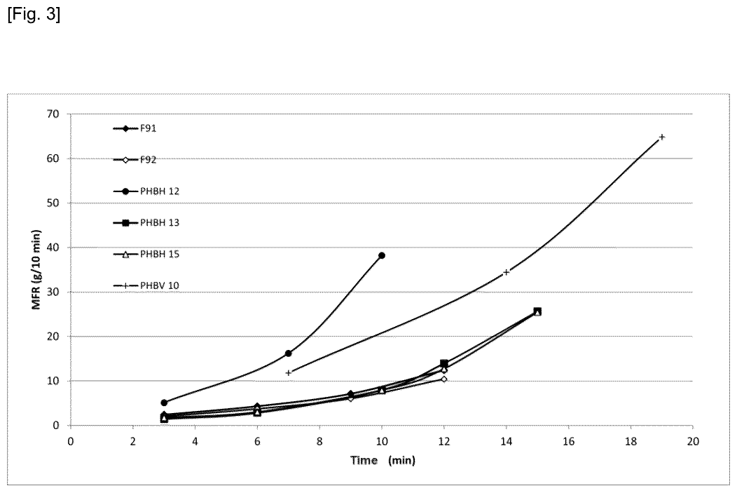

FIG. 3 shows the formulation flows (MFR) as a function of time in the plastometer.

As shown in FIG. 3, surprisingly and unexpectedly, the polymers P2 thermally stabilize the polymers P1, as well as the formulations based thereon.

The implementation of the formulations according to the invention is thus greatly facilitated.

### Example 4: Study of the Impact on Oxygen Permeability

The oxygen permeability of capsules obtained from different polymers and different formulations was measured according to the standard ASTM F1307 or ISO 15105-2.

Table 6 shows the results obtained for permeability to oxygen.

TABLE 6

| | [cm³/capsule/24 hrs at 0, 21 atm] |
|---|---|
| | at 23° C. and 50% RH |
| PHBH 13 | 6.6 × 10⁻³ |
| PHBV 10 | 2.4 × 10⁻³ |
| F89 | 1.3 × 10⁻³ |
| F90 | 3.1 × 10⁻³ |
| F91 | 2.35 × 10⁻³ |
| F92 | 2.25 × 10⁻³ |
| F93 | 1.9 × 10⁻³ |
| F94 | 2.85 × 10⁻³ |

The incorporation of P2 polymers does not significantly deteriorate the permeability of the material to oxygen while, as already mentioned, considerably improving the mechanical and thermal properties of the capsules.

The best oxygen permeability is obtained with comparative formulations F93 and F89 but with low values of impact strength and elongation at break and high crystallinity which has the effect of weakening the capsule which may make it brittle during transport, when passing through the filling lines or when using same in machines for extracting the drink.

The formulations F91, F92 and F94 according to the invention have a plasticizing effect compared to a comparative formulation wherein an inorganic filler has been added in order to increase the permeability to oxygen, without significantly being detrimental to the permeability to oxygen on the final formulation.

In conclusion, the subject matter of the invention has a quadruple interest: the controlled combination according to the invention of polymers P1 with a degree of crystallinity greater than or equal to 50%, and the addition of polymers P2 with a degree of crystallinity less than or equal to 30% and more particularly less than or equal to 5%, whether added or not (in inorganic fillers, plasticizers, etc.) serves to:
meet the requirements of mechanical properties of use of capsules in a machine for extracting a beverage, P2 polymers providing impact strength and flexibility;
meet the requirements of mechanical properties during transport and passage on the filling lines of the capsules, P2 polymers providing impact strength and flexibility;
provide a very good level of permeability to gases, in particular to oxygen: P2 polymers make it possible to obtain high degrees of degrees of crystallinity, with or without nucleating agents, the weakly crystalline or rather amorphous character of P2 polymers, even in low concentrations,
improves the thermal stability of formulations when used in plastics processing, at high shear rates and high temperature levels

Thereby, the presence of at least one amorphous polymer with a degree of crystallinity of less than or equal to 5% in the capsule formulation makes it possible to obtain a capsule that meets the oxygen permeability requirements and that does not break while remaining biodegradable, especially in industrial composting and domestic composting conditions (aerobic biological process) or by anaerobic digestion (anaerobic biological process), even when the container consists of a single layer of formulation

In conclusion, the capsules obtained according to the invention, i.e. obtained from a formulation comprising a weakly crystalline or rather amorphous polymer and a rather crystalline polymer are not brittle and always have good rigidity as well as impact resistance and elongation at break sufficient to be compatible with Nespresso® type machines. The addition of a plasticizer (such as Citrofol) does not achieve such good mechanical strength and oxygen barrier properties.

Thereby, the presence of at least one weakly crystalline copolymer of the PHA family or rather amorphous in the capsule formulation makes it possible to obtain a capsule that meets the oxygen permeability requirements and that does not break while remaining biodegradable, in particular in industrial and domestic composting conditions, even when the container consists of a single layer of formulation.

1. A capsule for preparing a beverage, said capsule comprising a container comprising at least one side wall (4) having a circular rim (5), wherein the side wall and the circular rim are formed by injection molding or by thermoforming of at least one formulation comprising:
(i) at least one polymer P1 chosen from polyhydroxyalkanoates (PHA); and
(ii) at least one polymer P2 chosen from polyhydroxyalkanoates (PHA), said polymer P1 having a degree of crystallinity (KC1) greater than or equal to 50%, and said polymer P2 having a degree of crystallinity (KC2) of less than or equal to 30%, preferably less than or equal to 5%.

2. The capsule according to claim 1, wherein said polyhydroxyalkanoates are chosen from polyhydroxybutyrate (PHB) polymers, preferably the polymer P1 and/or the polymer P2 are PHB copolymers.

3. The capsule according to claim 1, wherein the polymer P1 contains monomer units M1a of hydroxybutyrates 3HB and monomer units M1b selected from hydroxyvalerate HV, 3-hydroxyhexanoate HH or 4-hydroxybutyrate 4HB, M1a being different from M1b, and/or the polymer P2 contains monomer units M2a of hydroxybutyrates 3HB and monomer units M2b selected from hydroxyvalerate HV, 3-hydroxyhexanoate HH or 4-hydroxybutyrate 4HB, M2a being different from M2b, preferably the weight ratio M1b/M1a is less than or equal to 0.7, preferably less than or equal to 0.6 and/or the M2b/M2a weight ratio is greater than or equal to 0.05, preferably ranges from 0.1 to 1, else preferably from 0.2 to 0.9.

4. The capsule according to claim 1, wherein the polymer P1 and/or the polymer P2 are obtained by aerobic and/or anaerobic fermentative engineering in a bio-based manner.

5. The capsule according to claim 1, wherein the polymer(s) P1 represent(s) from 70 to 99% by weight, preferably from 80 to 98% by weight, of the total weight of the polymers P1 and P2 and/or the polymer(s) P2 represent(s) from 1% to 30% by weight, preferably from 2% to 20% by weight, else preferably from 3% to 10% by weight, of the total weight of the polymers P1 and P2.

6. The capsule according to claim 1, wherein the formulation comprises from 50 to 99.9% by weight, preferably from 75 to 99.5% by weight, advantageously from 90 to 99% by weight, of polymer(s) P1 and P2, with respect to the total weight of the formulation.

7. The capsule according to claim 1, wherein the formulation further comprises at least one inorganic or organic filler, preferably in a proportion ranging from 0.1 to 50% by weight, preferably from 0.5 to 25% by weight, advantageously from 1 to 15% by weight, preferably said filler is chosen from silica, silicates, double laminar hydroxides (HDL), titanium oxide, vitamin E, plasticized animal or vegetable proteins, or mixtures thereof, with respect the total weight of the formulation.

8. The capsule according to claim 7, wherein the BET specific surface area of the silicates is comprised between 1 and 250 m²/g and/or the median diameter of the silicates is comprised between 0.5 and 20 μm and/or the dimensional form factor of the silicates is greater than or equal to 1:2.

9. The capsule according to claim 1, wherein the formulation further comprises at least one polyvinyl alcohol or ethylene vinyl, preferably in a quantity ranging from 1 to 30% by weight, preferably from 2 to 20% by weight, advantageously from 5 to 10% by weight, with respect to the total weight of the formulation.

10. The capsule according to claim 1, wherein the capsule:
is biodegradable and/or compostable under industrial or domestic conditions or by anaerobic digestion and/or
contains at least 80% by weight of bio-based carbon, relative to the total weight of the carbon atoms of the capsule.

11. The capsule according to claim 1, wherein the container includes a bottom and wherein the bottom, the side wall and the circular rim are formed by injection molding or by thermoforming, preferably in only one layer of said formulation in a mold.

12. The capsule according to claim 1, containing a substance in the form of powder or liquid, said capsule comprising a seal welded on the circumference of the rim of the container, preferably the seal comprising a monolayer or multilayer film, said film comprising one or a plurality of materials chosen from materials that are biodegradable and compostable according to an aerobic biological process and/or that can be broken down by anaerobic digestion according to an anaerobic processus, preferably the material is chosen from paper, nonwoven fabrics, cellulose, SiOx layers, polylactic acid polymers, polyhydroxyalkanoates, hybrid layers of organic polymer and inorganic fibers, layers coated with polyvinyl alcohol or with ethylene-vinyl alcohol copolymer, layers metallized preferably with aluminum, the layers of materials being optionally separated by a layer of adhesive.

13. The capsule according to claim 12, wherein the seal consists of a multilayer film comprising:
I) a film of paper or filter paper,
ii) a barrier layer, preferably the barrier layer comprising one or a plurality of layers chosen from:
a hybrid barrier layer comprising an organic polymer and inorganic compounds, and/or
a SiOx barrier, and/or
a cellulose barrier layer,
iii) a layer of nonwoven fabric, said layer of nonwoven fabric being inside the capsule.

14. The capsule according to claim 12, wherein the seal consists:
of a multilayer film comprising:
i) a barrier layer,
ii) a film containing biopolymers such as polyhydroxyalkanoates PHA or polybutylenadipate-terephthalate PBAT or polybutylensuccinate PBS or polybutylene-co aliphatic co-terephthalate PBAIT or polylactic acids PLA, Or of a multilayer film comprising:
i) a film containing biopolymers such as polyhydroxyalkanoates PHA or polybutylenadipate-terephthalate PBAT or polybutylensuccinate PBS or polybutylene-co aliphatic co-terephthalate PBAIT or polylactic acids PLA,
ii) a barrier layer,
iii) a film containing biopolymers such as polyhydroxyalkanoates PHA or polybutylene co-adipate co-terephthalate PBAT or polybutylene succinate PBS or polybutylene co-aliphatic-co terephthalate PBAIT or polylactic acids PLA.

15. A manufacturing method for a capsule according to claim 1, comprising the following steps:
a) Preparing the formulation by mixing the ingredients, where the ingredients can be optionally extruded,
b) injection molding of the formulation obtained in step a) in a mold so as to form a layer of the of at least the side wall and the circular rim of the container, optionally one or a plurality of layers of the container can be injection molded using a formulation different from the formulation in step a),
c) filling the container with the substance in powder or liquid form, if the bottom is not molded by injection of the formulation, then the filling step is preceded by a step of placing a single-layer or multi-layer bottom to form the container,
d) optionally, closing the container using the seal for forming the capsule,
Or comprising the following steps:
a) Preparing the formulation by mixing the ingredients, where the ingredients can be optionally extruded,
b) Manufacturing plates or a film by extrusion of the formulation before calendaring or blowing, optionally manufacturing one or a plurality other layers of at least the side wall and the circular rim of the container by extrusion using at least one formulation different from the formulation of step a), e.g. using a formulation of PVOH or EVOH,
c) Shaping by thermoforming of the plate or film into a suitable shape,
d) filling the container with the substance in powder or liquid form, if the bottom is not shaped by thermoforming during step c), then the filling step is preceded by a step of placing a single-layer or multi-layer bottom to form the container,
e) optionally, closing the container using the seal for forming the capsule.
